(19) United States
(12) Patent Application Publication
(10) Pub. No.: US 2010/0028173 A1
(43) Pub. Date: Feb. 4, 2010

(54) INVERTER-INTEGRATED ELECTRIC COMPRESSOR

(75) Inventors: Yuki Ichise, Aichi (JP); Takayuki Watanabe, Aichi (JP); Takeshi Hirano, Aichi (JP); Takayuki Hagita, Aichi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MITSUBISHI HEAVY INDUSTRIES, LTD., Tokyo (JP)

(21) Appl. No.: 12/442,565

(22) PCT Filed: Sep. 26, 2008
(86) PCT No.: PCT/JP2008/067552

§ 371 Date: Mar. 24, 2009

(30) Foreign Application Priority Data
Sep. 28, 2007 (JP) 2007-253187

(51) Int. Cl. F04B 39/06; F04B 17/03; B60H 1/32

(52) U.S. Cl. 417/371; 417/410.1

(57) ABSTRACT

It is an object to provide an inverter-integrated electric compressor capable of enhancing the cooling of high-voltage components, which generate a large amount of heat, among components of an inverter device disposed inside an inverter box integrated with a housing. An inverter-integrated electric compressor (1) for a vehicle air conditioner includes an inverter box (11) that is integrated with the periphery of a housing (2) accommodating an electric motor (9) and a compressing mechanism, an inverter device (20) that converts DC power to three-phase AC power and supplies it to the electric motor (9) being accommodated in the interior thereof, wherein, when the electric compressor is installed in a vehicle (30), among components of the inverter device (20), high-voltage components (21, 22) generate a large amount of heat are disposed inside the inverter box (11) at positions facing forward in a vehicle traveling direction.

### TECHNICAL FIELD

The present invention relates to an inverter-integrated electric compressor that is integrated with an inverter device suitable for use as an air conditioning compressor installed in a vehicle.

### BACKGROUND ART

An inverter-integrated electric compressor is constructed of an inverter box integrated with the periphery of a housing, which accommodates an electric motor and a compressing mechanism, the inverter box accommodating an inverter device that converts DC power received from a power supply, such as a generator or a battery, into three-phase AC power and feeds it to the electric motor. The inverter device includes high-voltage components, such a capacitor, an inductor, a common mode coil, and a power board (a board on which power devices, such as insulated gate bipolar transistors (IGBTs), are mounted), as components thereof. Not only do these high-voltage components generate a large amount of heat, but they are also heated by radiation heat caused by the electric compressor being disposed in a high-temperature environment, such as inside the engine compartment of a vehicle.

Since the internal temperature of the engine compartment of a vehicle may reach several tens of degrees Celsius above 100° C., the high-voltage components are manufactured to have heat resistance corresponding to such a temperature. However, the components are degraded by being exposed to high temperatures and extreme heat close to the heat resistance limit for a long period of time, and also the durability decreases over time. Thus, with the above-described inverter-integrated electric compressor, low-temperature refrigerant gas drawn into the housing is usually used to cool high-voltage components of the inverter device, which are disposed inside the inverter box and separated by the housing walls (for example, refer to Patent Document 1). Patent Document 2 proposes providing an inverter device separately from an electric compressor, with a cool-air introduction guide provided on the front surface of a vehicle, to perform forced cooling by driving wind, and to freely select the installation position of the electric compressor so as to reduce the heat entering from outside.

Patent Document 1:

Japanese Unexamined Patent Application, Publication No. 2002-191153

Patent Document 1:

Japanese Unexamined Patent Application, Publication No. 2002-219930

### DISCLOSURE OF INVENTION

For an inverter-driven electric compressor for an air conditioner, there is a strong need for an inverter-integrated type, which is constructed by integrating an inverter device with an electric compressor, so as to facilitate mounting to a vehicle. Moreover, since recently the engine compartment has become densely packed and thus the mounting space has been reduced, there is a need to reduce the size as much as possible. Therefore, as described in Patent Document 2, it is difficult to employ a configuration in which the inverter device is provided separately. Furthermore, as described in Patent Document 1, even when the inverter is integrated, the cooling structure using low-temperature refrigerant gas cannot be too large. Therefore, there is a limit in cooling the high-voltage components, which are disposed inside the inverter box, from the inside with low-temperature refrigerant gas.

Thus, among the components of the inverter device, which is disposed inside the inverter box, in order to guarantee the operation of high-voltage components, such as the capacitor, the inductor, the common mode coil, and the power board (a board on which the power devices, such as IGBTs, are mounted), in high-temperature environments and to assure heat resistance and reliability, it is necessary to suppress the temperature rise as much as possible, not only by cooling the high-voltage components from the inside of the housing, but also by effectively cooling the high-voltage components using another structure.

The present invention has been conceived in light of the problems described above, and it is an object of the present invention to provide an inverter-integrated electric compressor capable of enhancing the cooling of high-voltage components, which have high heating values, of components among in an inverter device disposed inside an inverter box integrated with a housing.

To solve the problems described above, the inverter-integrated electric compressor according to the present invention provides the following solutions.

Specifically, an inverter-integrated electric compressor according to an aspect of the present invention is an inverter-integrated electric compressor for a vehicle air conditioner in which an inverter box is integrated with a periphery of a housing accommodating an electric motor and a compressing mechanism, an inverter device that converts DC power to three-phase AC power and supplies it to the electric motor being accommodated in the interior thereof, wherein, when installed in a vehicle, among components of the inverter device, high-voltage components having high heating values, are disposed inside the inverter box at positions facing forward in a vehicle traveling direction.

According to this aspect, among the components of the inverter device that are disposed inside the inverter box, high-voltage components generate a large amount of heat are disposed in the inverter box at positions facing forward in a vehicle traveling direction with the electric compressor mounted on the vehicle, and therefore, the high-voltage components can be cooled not only from the inside of the electric compressor but also by using the driving wind generated when the vehicle is traveling, which is applied to the surface of the inverter box facing forward in the vehicle traveling direction. Therefore, the cooling effect of the high-voltage components constituting in the inverter device can be enhanced, and the reliability of the inverter-integrated electric compressor can be improved by suppressing a temperature rise.

In the inverter-integrated electric compressor according to the above-described aspect, when the electric compressor is mounted such that a motor shaft direction is aligned parallel to the vehicle traveling direction, an end section of the electric-motor accommodating section of the housing and an end section in the motor shaft direction of the inverter box may be mounted facing forward in the vehicle traveling direction, and the high-voltage components may be disposed at an end section facing forward in the vehicle traveling direction inside the inverter box.

According to the above-described aspect, when the electric compressor is disposed such that a motor shaft direction is parallel to the vehicle traveling direction, an end section of the electric-motor accommodating section of the housing and an end section in the motor shaft direction of the inverter box may be mounted facing forward in the vehicle traveling direction, and the high-voltage components may be disposed inside the inverter box at an end section facing forward in the vehicle traveling direction; therefore, the high-voltage components constituting the inverter device can be disposed at positions where the most wind generated when the vehicle is traveling is applied to the inverter box. Therefore, the wind can be efficiently used to cool the high-voltage components constituting the inverter device, and reliability can be improved.

In the inverter-integrated electric compressor according to the above-described aspect, when the electric compressor is mounted such that a motor shaft direction is aligned orthogonal to the vehicle traveling direction, an end section of the electric-motor accommodating section of the housing and an end section in the motor shaft direction of the inverter box may be mounted facing forward in the vehicle traveling direction, and the high-voltage components may be disposed at an end section facing forward in the vehicle traveling direction inside the inverter box.

According to the above-described aspect, when the electric compressor is disposed such that a motor shaft direction is orthogonal to the vehicle traveling direction, an end section of the electric-motor accommodating section of the housing and an end section in the motor shaft direction of the inverter box may be mounted facing forward in the vehicle traveling direction, and the high-voltage components may be disposed inside the inverter box at an end section facing forward in the vehicle traveling direction; therefore, the high-voltage components constituting the inverter device can be disposed at positions where the most wind generated when the vehicle is traveling is applied to the inverter box. Therefore, the wind can be efficiently used to cool the high-voltage components constituting the inverter device, and reliability can be improved.

In the inverter-integrated electric compressor according to the above-described aspect, the high-voltage components may be constructed of at least one of a capacitor, an inductor, a common mode coil, a power board, etc. which constitute the inverter device.

According to the above-described aspect, since the high-voltage components include at least one of a capacitor, an inductor, a common mode coil, and a power board (a board on which the power devices, such as IGBTs are mounted), which constitute the inverter device, at positions in the inverter box facing the vehicle traveling direction, these high-voltage components can be cooled by efficiently using the wind generated when the vehicle is traveling. Therefore, the cooling effect on the high-voltage components constituting the inverter device can be enhanced, and the reliability of the inverter-integrated electric compressor can be improved even more by suppressing a temperature rise.

In the inverter-integrated electric compressor according to the above-described configuration, at least one of the high-voltage components may be disposed inside the inverter box near a refrigerant suction port which is provided at an end section of the electric-motor accommodating section of the housing.

According to the above-described aspect, since at least one of the high-voltage components is disposed inside the inverter box near a refrigerant suction port which is provided at an end section of the electric-motor accommodating section of the housing, the high-voltage components can be cooled with low-temperature refrigerant gas drawn into the housing through the refrigerant suction port. Therefore, the cooling of the high-voltage components can be enhanced even more, and the reliability can be improved even more by suppressing a temperature rise.

In the inverter-integrated electric compressor according to the above-described aspect, at least one of the high-voltage components may be disposed upstream in the flow direction of a refrigerant gas drawn through the refrigerant suction port with respect to a stator of the electric motor.

According to the above-described aspect, since at least one of the high-voltage components is disposed upstream in the flow direction of a refrigerant gas drawn through the refrigerant suction port with respect to a stator of the electric motor, the high-voltage components can be cooled with refrigerant gas, which is drawn into the housing through the refrigerant suction port, having the lowest temperature. Therefore, the high-voltage components can be efficiently cooled, and the reliability of the inverter-integrated electric compressor can be improved even more by suppressing a temperature rise.

In the inverter-integrated electric compressor according to the above-described aspect, among the high-voltage components, at least one of the capacitor, the inductor, and the common mode coil may be disposed upstream in the flow direction of a refrigerant gas drawn through the refrigerant suction port with respect to the power board.

Accordingly, since at least one of the capacitor, the inductor, and the common mode coil is disposed upstream in the flow direction of a refrigerant gas drawn through the refrigerant suction port with respect to the power board. Therefore, the capacitor, the inductor, and the common mode coil, which are high-voltage components that have a relatively low temperature, can be cooled first. In this way, a temperature rise in the refrigerant can be suppressed as much as possible, and the power board (board on which power devices, such as IGBTs, are mounted) disposed downstream can be efficiently cooled. Therefore, the cooling effect on all high-voltage components constituting the inverter device can be enhanced even more, and the reliability of the inverter-integrated electric compressor can be improved even more by suppressing the temperature rise.

According to the present invention, since the high-voltage components are disposed in the inverter box at positions facing forward in the vehicle traveling direction in order to enable the high-voltage components be cooled, not only from the inside of the electric compressor, but also by wind generated when the vehicle is traveling, the cooling effect on the high-voltage components of the inverter device is enhanced, and the reliability of the inverter-integrated electric compressor is improved by suppressing the temperature rise.

### BRIEF DESCRIPTION OF DRAWINGS

FIG. 1 is a partial longitudinal sectional view along an inverter box section of an inverter-integrated electric compressor according to a first embodiment of the present invention.

FIG. 2 is a plan view showing a cross-section of part of the inverter-integrated electric compressor shown in FIG. 1, on the inverter box side.

FIG. 3 is a perspective view illustrating, in outline, the positions of high-voltage components inside the inverter box of the inverter-integrated electric compressor according to the first embodiment of the present invention.

FIG. 4 is a layout drawing in plan view illustrating the mounting state, on a vehicle, of the inverter-integrated electric compressor according to the first embodiment of the present invention.

FIG. 5 is a layout drawing in plan view illustrating the mounting state, on a vehicle, of an inverter-integrated electric compressor according to a second embodiment of the present invention.

### EXPLANATION OF REFERENCE SIGNS

1: inverter-integrated electric compressor
2: housing
3: motor housing
6: refrigerant suction port
9: electric motor
9A: stator
11: inverter box
20: inverter device
21: capacitor
22: inductor
23: inverter module (including power board)
30: vehicle
A: vehicle traveling direction
L: motor shaft direction

### BEST MODE FOR CARRYING OUT THE INVENTION

Embodiments of the present invention will be described with reference to the drawings.

First Embodiment

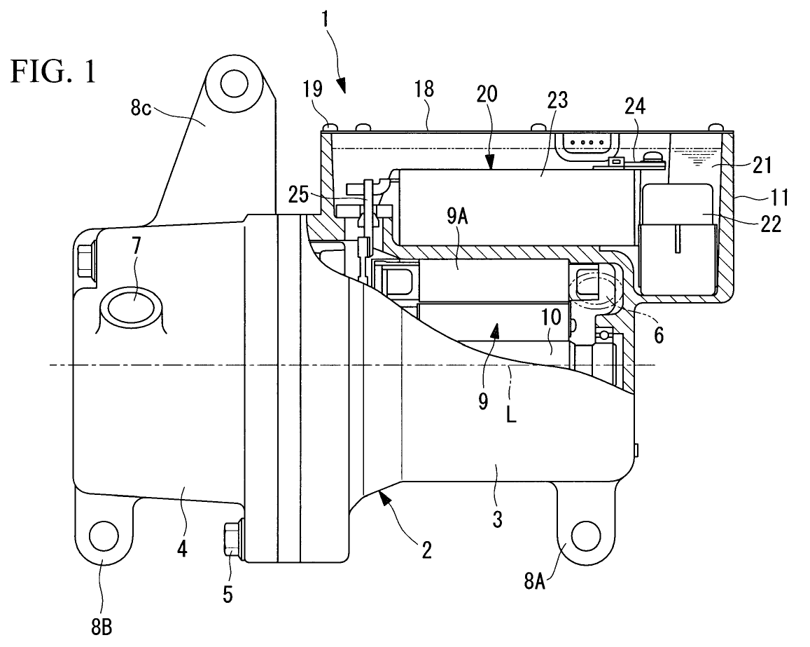

A first embodiment of the present invention will be described below with reference to FIGS. 1 to 4.

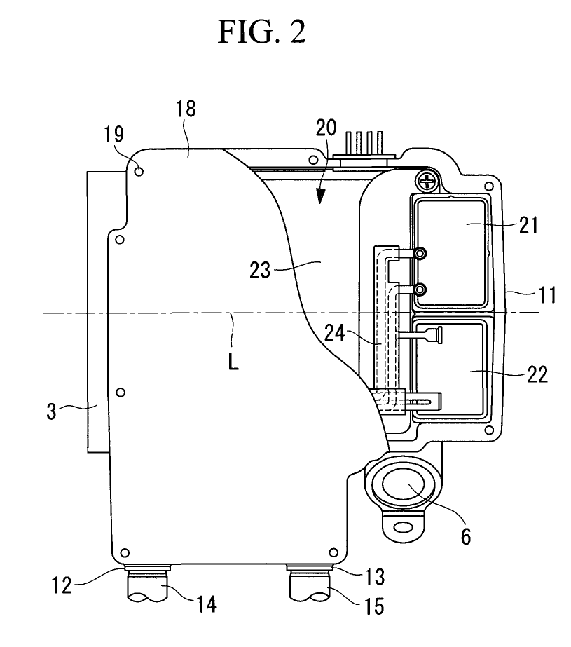

FIG. 1 illustrates a partial longitudinal sectional view of an inverter box section of an inverter-integrated electric compressor according to the first embodiment of the present invention. FIG. 2 is a plan view illustrating part of FIG. 1. An inverter-integrated electric compressor 1 includes a housing 2 that forms the outer shell thereof. The housing 2 is constructed by integrating a motor housing 3 for accommodating an electric motor 9 and a compressor housing 4 for accommodating a compressing mechanism, which is not shown in the drawing, by tightening bolts 5. The motor housing 3 and the compressor housing 4 are formed by aluminum die-casting.

The electric motor 9 and the compressing mechanism, which is not shown in the drawing, accommodated inside the housing 2 are linked via a motor shaft 10 (see FIG. 1), and the compressing mechanism is driven by rotation of the electric motor 9. A refrigerant suction port 6 (see FIG. 2) is provided at one end (on the right side in FIG. 1) of the motor housing 3, so that low-temperature and low-pressure refrigerant gas drawn from this refrigerant suction port 6 into the motor housing 3 flows around the electric motor 9 and is drawn into the compressing mechanism, where the refrigerant gas is compressed. As a result of being compressed by the compressing mechanism, the high-temperature and high-pressure refrigerant gas is released into the compressor housing 4 and is expelled to the outside via a discharge port 7 provided at the other end (on the left side in FIG. 1) of the compressor housing 4.

The housing 2 has three attachment legs 8A, 8B, and 8C: two at a lower part at one end (on the right side in FIG. 1) of the motor housing 3 and a lower part at the other end (on the left side in FIG. 1) of the compressor housing 4; and one at an upper part of the compressor housing 4. The inverter-integrated electric compressor 1 is secured to a vehicle via these attachment legs 8A, 8B, and 8C by fixing it with a bracket and bolts on a side wall, etc. of a driving engine, which is provided inside the engine compartment of the vehicle. The inverter-integrated electric compressor 1 is usually cantilevered at three points on the upper and lower sides with a securing bracket such that the motor shaft direction L is in the front-to-back direction or the right-to-left direction.

A box-shaped inverter box 11 is integrated with the peripheral section of the motor housing 3 at the upper section of the motor housing 3. FIG. 1 is a partial longitudinal sectional view showing a cross-section of the inverter accommodating section 11. As shown in FIG. 1 to 3, the inverter box 11 is shaped as a box open at the top and surrounded by a circumferential wall having a predetermined height. The upper opening is sealed with a cover member 18 secured with screws 19, with a sealing material (not shown) therebetween. Two power-supply-cable lead-out holes 12 and 13 are provided on a side surface of the inverter box 11 so that a power supply, such as a generator or a battery, and an inverter device 20 mounted inside the inverter box 11 can be connected via two P-N power-supply cables 14 and 15.

The inverter device 20 mounted inside the inverter accommodating section 11 includes, for example, P-N terminals (not shown) to be connected to the power-supply cable; high-voltage components, such as a capacitor 21, an inductor 22 and a common mode coil (not shown), which are provided on a power supply line; an inverter module 23 that forms the core of the inverter device 20; a bus-bar assembly 24 including integrated bus bars, which constitute the electrical wiring inside the inverter device 20, and being composed of insert-molded insulating resin material; and a glass-sealed terminal 25 that supplies a three-phase AC power, which is converted at the inverter device 20, to the electric motor 9. The inverter module 23 is a module formed of a power board, which is provided with a plurality of semiconductor power switching devices (power devices, such as IGBTs) (not shown) and a power-system controlling circuit for operating the semiconductor power switching devices, and a CPU board on which is mounted a circuit having devices that operate at low voltage, such as a central processing unit (CPU).

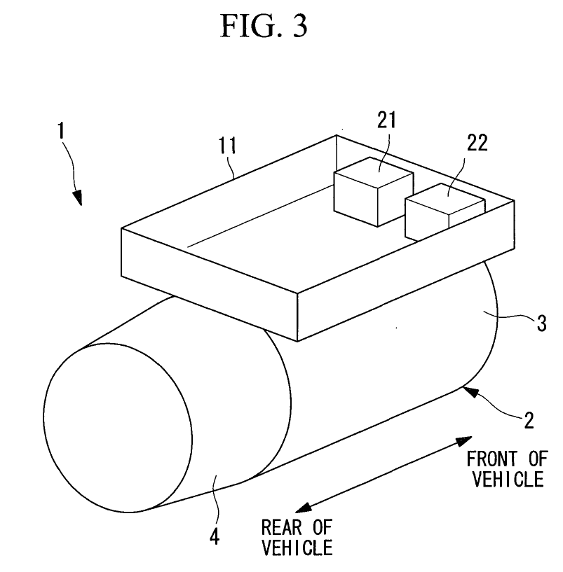

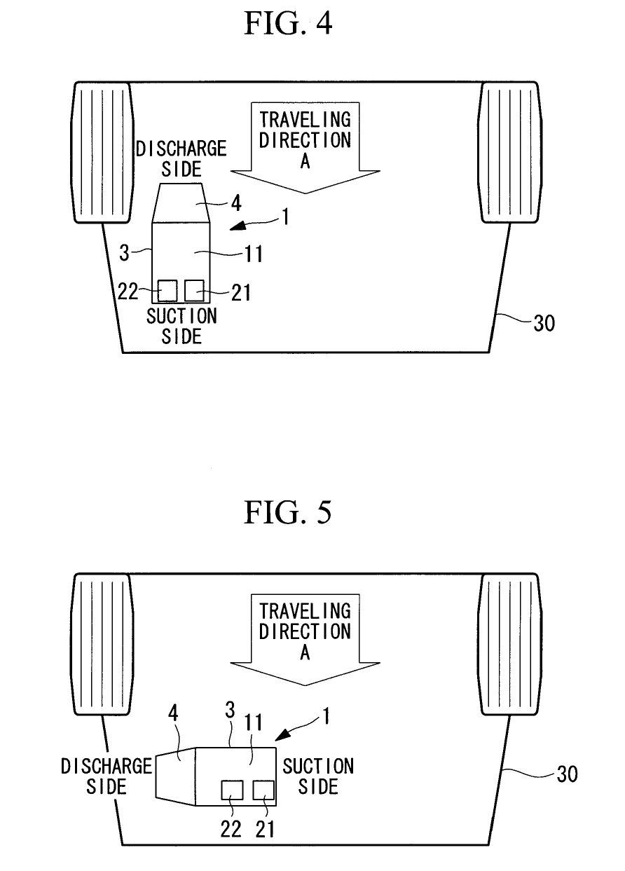

As shown in FIG. 4, the inverter-integrated electric compressor 1 having the above-described configuration is mounted in a vehicle 30 in the front-to-back direction such that the motor shaft direction L (the Z direction of the X, Y, and Z axes of the inverter-integrated electric compressor 1 shown in FIG. 3) is parallel to the traveling direction A of the vehicle 30, which is indicated by an arrow. In such a case, the inverter-integrated electric compressor 1 is mounted in an orientation in which an end section (right end section in FIG. 1) where the refrigerant suction port 6 of the motor housing 3 is provided and an end section (right end section in FIGS. 1 and 2) of the inverter box 11 face forward in the vehicle traveling direction.

According to this embodiment, in the inverter-integrated electric compressor 1, which is mounted in the above-described orientation, at least one of the high-voltage components, among the components of the inverter device 20 generate a large amount of heat, i.e., the capacitor 21, the inductor 22, the common mode coil (not shown), and a power board (included in the inverter module 23) on which power devices such as IGBTs are mounted, is disposed at a position facing forward in the vehicle traveling direction in the inverter box 11, which is integrated with the peripheral section of the motor housing 3. Here, as shown in FIGS. 1 to 3, examples in which the capacitor 21 and the inductor 22 are disposed at positions facing forward in the vehicle traveling direction in the inverter box 11 are illustrated.

The capacitor 21 and the inductor 22 are disposed at positions close to the refrigerant suction port 6, which is provided at an end of the motor housing 3, upstream in the flow direction of the refrigerant gas, which is drawn through the refrigerant suction port 6 and flows around the electric motor 9, with respect to a stator 9A of the electric motor 9, which is provided inside the motor housing 3. Moreover, the high-voltage components, such as the capacitor 21, the inductor 22, and the common mode coil (not shown), are disposed upstream in the refrigerant flow direction with respect to the power board, which is provided in the inverter module 23.

According to the above-described configuration of this embodiment, the following advantages are achieved.

The inverter-integrated electric compressor 1 is rotationally driven by converting DC power supplied from a power supply, such as a generator or a battery, via the power-supply cables 14 and 15 into three-phase AC power, having a predetermined frequency corresponding to the air conditioning load, at the inverter device 20 and by supplying this to the electric motor 9. In this way, the compressing mechanism is driven to compress the low-temperature and low-pressure refrigerant gas, which is drawn through the refrigerant suction port 6 provided at an end of the motor housing 3, to a high-temperature and high-pressure state. This high-temperature and high-pressure compressed gas is released into the compressor housing 4 and is then released to the outside through the discharge port 7.

The low-temperature and low-pressure refrigerant gas drawn through the refrigerant suction port 6 is drawn into a space between an end section of the motor housing 3 and the stator 9A of the electric motor 9, flows around the stator 9A to the compressor housing 4, and is drawn into the compressing mechanism. During this period, the high-voltage components that are installed inside the inverter box 11 integrated with the motor housing 3 and that are heat-radiating parts constituting the inverter device 20, such as the power devices (IGBTs) on the power board included in the heat-radiating inverter module 23, the capacitor 21, the inductor 22, and the common mode coil (not shown), are cooled from the inside of the housing 2 through the outer peripheral wall of the motor housing 3.

Among the components of the inverter device 20 disposed inside the inverter box 11, at least one of the high-voltage components having high heating values, such as the capacitor 21, the inductor 22, the common mode coil (not shown), and the power devices (IGBTs) on the power board, or in this embodiment, two components, i.e., the capacitor 21 and the inductor 22, are disposed in the inverter box 11 at positions facing forward in the vehicle traveling direction, with the inverter-integrated electric compressor 1 being mounted on the vehicle 30. Therefore, the capacitor 21 and the inductor 22 are also cooled from the outside by wind that is generated when the vehicle is traveling and that is applied to the surface of the inverter box 11 facing forward in the vehicle traveling direction.

In this way, among the high-voltage components constituting the inverter device 20, the capacitor 21 and the inductor 22 are not only cooled from the inside of the housing 2 but are also cooled from the outside by wind that is generated when the vehicle is traveling and that is applied to the surface of the inverter box 11 facing forward in the vehicle traveling direction. Therefore, the cooling effect on the high-voltage components constituting the inverter device 20 can be increased, and a temperature rise therein can be suppressed. Therefore, the reliability in terms of heat resistance of the inverter-integrated electric compressor 1 can be improved.

Among the above-described high-voltage components, the capacitor 21 and the inductor 22 are disposed inside the inverter box 11 near the refrigerant suction port 6, which is provided at an end section of the motor housing 3; therefore, the capacitor 21 and the inductor 22 can be cooled by refrigerant gas, having a relatively low temperature, drawn through the refrigerant suction port 6 into the motor housing 3. In this way, cooling of the capacitor 21 and the inductor 22 can be enhanced, a temperature rise therein can be suppressed, and thus reliability can be improved.

Moreover, since the capacitor 21 and the inductor 22 are disposed upstream in the flow direction of the refrigerant gas, which is drawn through the refrigerant suction port 6, with respect to the stator 9A of the electric motor 9, the inside of the motor housing 3 is cooled with the refrigerant gas, having the lowest temperature, drawn through the refrigerant suction port 6 into the motor housing 3. Therefore, the capacitor 21 and the inductor 22 can be efficiently cooled, and the temperature rise therein can be suppressed so as to improve the reliability even more.

Since the inverter module 23 including the power board on which power devices, such as IGBTs, are mounted is disposed downstream of the capacitor 21, the inductor 22, and the common mode coil (not shown) in the flow direction of the refrigerant gas drawn through the refrigerant suction port 6, a temperature rise in the refrigerant gas can be suppressed by first cooling the capacitor 21, the inductor 22, and the common mode coil, which have a relatively low temperature. The refrigerant gas can further cool the inverter module 23, including the power devices, such as IGBTs, that are mounted on the power board. Accordingly, all of the high-voltage components can be efficiently cooled, and thus, a temperature rise of the entire inverter device 20 can be suppressed.

Second Embodiment

Next, a second embodiment of the present invention will be described with reference to FIG. 5.

This embodiment differs from the above-described first embodiment in that the mounting orientation of the inverter-integrated electric compressor 1 in the vehicle 30 is different and thus the positioning of the high-voltage components is different. Other aspects are the same as those in the first embodiment, and thus, descriptions thereof are omitted.

In this embodiment, as shown in FIG. 5, the inverter-integrated electric compressor 1 is mounted on the vehicle 30 in the left-to-right direction such that the motor shaft direction L (the Z axis direction of the X, Y, and Z axes of the inverter-integrated electric compressor 1 shown in FIG. 3) is orthogonal to the traveling direction A of the vehicle 30, which is indicated by an arrow.

In such a case, the inverter-integrated electric compressor 1 is mounted in an orientation such that the side section (lower surface in FIG. 2) on which the refrigerant suction port 6 of the motor housing 3 is provided and the side surface (lower surface in FIG. 2) in which the power-supply-cable lead-out holes 12 and 13 of the inverter box 11 are formed facing forward in the vehicle traveling direction. Then, as shown in FIG. 5, among the high-voltage components, the capacitor 21 and the inductor 22 are disposed on the side section inside the inverter box 11, facing forward in the vehicle traveling direction.

As described above, when the inverter-integrated electric compressor 1 is mounted such that the motor shaft direction L is orthogonal to the vehicle traveling direction, by employing a configuration in which at least one high-voltage component constituting the inverter device 20, i.e., the capacitor 21 and the inductor 22, is disposed on a side section in the inverter box 11, facing forward in the vehicle traveling direction, the capacitor 21 and the inductor 22 can be disposed at positions where the maximum amount of wind generated when the vehicle is traveling flows around the inverter box 11. Therefore, the high-voltage components, the capacitor 21 and the inductor 22 of the inverter device 20 can be efficiently cooled by the wind from the outside, and thus heat-resistance reliability can be improved even more.

The present invention is not limited to the above-described embodiments, and various modifications may be made so long as they do not depart from the spirit of the invention. For example, the above-described embodiment was described in terms of an example in which, among high-voltage components constituting the inverter device 20, i.e., the capacitor 21, the inductor 22, the common mode coil, and the power board on which the power devices such as IGBTs are mounted, the capacitor 21 and the inductor 22 are disposed at positions facing forward in the vehicle traveling direction inside the inverter box 11. The high-voltage components disposed at these positions may be selected from any combination including at least one of the high-voltage components. When two or more high-voltage components are disposed, the combination thereof is not particularly limited.

In the second embodiment shown in FIG. 5, suction side and discharge side of the inverter-integrated electric compressor 1 may be provided in opposite directions. In such a case, the high-voltage components are also disposed on the opposite side inside the inverter box 11. Moreover, in the present invention, the compressing mechanism provided inside the compressor housing 4 is not particularly limited, and any type of compressing mechanism, e.g., a rotary type, a scroll type, or a swash plate type, may be used. The inverter box 11 does not necessarily have to be integrated with the motor housing 3, and, instead, may be manufactured separately and assembled in an integrated manner.

1. An inverter-integrated electric compressor for a vehicle air conditioner in which an inverter box is integrated with a periphery of a housing accommodating an electric motor and a compressing mechanism, an inverter device that converts DC power to three-phase AC power and supplies it to the electric motor being accommodated in the interior thereof,
wherein, when installed in a vehicle, among components of the inverter device, high-voltage components generate a large amount of heat, are disposed inside the inverter box at positions facing forward in a vehicle traveling direction.

2. The inverter-integrated electric compressor according to claim 1, wherein, when the electric compressor is mounted such that a motor shaft direction is aligned parallel to the vehicle traveling direction, an end section of the electric-motor accommodating section of the housing and an end section in the motor shaft direction of the inverter box are mounted facing forward in the vehicle traveling direction, and the high-voltage components are disposed at an end section facing forward in the vehicle traveling direction inside the inverter box.

3. The inverter-integrated electric compressor according to claim 1, wherein, when the electric compressor is mounted such that a motor shaft direction is aligned orthogonal to the vehicle traveling direction, an end section of the electric-motor accommodating section of the housing and an end section in the motor shaft direction of the inverter box are mounted facing forward in the vehicle traveling direction, and the high-voltage components are disposed at an end section facing forward in the vehicle traveling direction inside the inverter box.

4. The inverter-integrated electric compressor according to claim 1, wherein the high-voltage components include at least one of a capacitor, an inductor, a common mode coil, a power board, etc. which constitute the inverter device.

5. The inverter-integrated electric compressor according to claim 4, wherein at least one of the high-voltage components is disposed inside the inverter box near a refrigerant suction port which is provided at an end section of the electric-motor accommodating section of the housing.

6. The inverter-integrated electric compressor according to claim 5, wherein at least one of the high-voltage components is disposed upstream in the flow direction of a refrigerant gas drawn through the refrigerant suction port with respect to a stator of the electric motor.

7. The inverter-integrated electric compressor according to claim 5, wherein, among the high-voltage components, at least one of the capacitor, the inductor, and the common mode coil is disposed upstream in the flow direction of a refrigerant gas drawn through the refrigerant suction port with respect to the power board.
